(19) United States
(12) Patent Application Publication
(10) Pub. No.: US 2022/0163333 A1
(43) Pub. Date: May 26, 2022

(54) Apparatus for Providing Specific Notification in Vehicle, System Including the Same, and Method for the Same

(71) Applicants: Hyundai Motor Company, Seoul (KR); Kia Corporation, Seoul (KR)

(72) Inventor: Hyun Woo Choi, Anyang-si (KR)

(21) Appl. No.: 17/353,251

(22) Filed: Jun. 21, 2021

(30) Foreign Application Priority Data
Nov. 20, 2020 (KR) 10-2020-0156979

(51) Int. Cl. G01C 21/34; G01C 21/36

(52) U.S. Cl. CPC G01C 21/343; G01C 21/3617; G01C 21/3697; G01C 21/3476; G01C 21/362

(57) ABSTRACT

An embodiment apparatus for providing a specific notification in a vehicle includes a processor configured to notify a to-do list based on a vehicle characteristic, in link with a to-do list application, and recommend a path based on the to-do list based on a user condition or priority set by a user and used for recommending the path when the recommendation of the path is required in relation to the to-do list, and a memory configured to store data used and an algorithm driven by the processor.

### CROSS-REFERENCE TO RELATED APPLICATIONS

This application claims the benefit of Korean Patent Application No. 10-2020-0156979, filed on Nov. 20, 2020, which application is hereby incorporated herein by reference.

### TECHNICAL FIELD

The present disclosure relates to an apparatus for providing a specific notification in a vehicle, a system including the same, and a method for the same.

### BACKGROUND

Recently, a calendar function has been provided to notify the schedule of a user to the user through a terminal in a vehicle.

A calendar linking function (Bluelink/UVO/Genesis Connected Service) applied to the vehicle may be provided through the link between an external server of the vehicle and a server which provides an external calendar application.

In other words, the terminal in the vehicle receives relevant calendar information (schedule information) from the external server to merely identify schedule information, and to provide a function of setting an appointment place as a destination.

However, conventionally, a to-do list application (which is used interchangeably with “ToDoList application” or “ToDoList app”), which is mainly used together with a calendar application and similar to the calendar application, is provided to merely notify calendar information and information on a to-do list, so it is necessary to enhance the use and the efficiency of the calendar information and the to-do list information.

### SUMMARY

The present disclosure relates to an apparatus for providing a specific notification in a vehicle, a system including the same, and a method for the same. Particular embodiments relate to a technology of making a specific notification available in a vehicle and automatically recommending a destination/path which are useful in the vehicle.

Embodiments of the present disclosure can solve problems occurring in the prior art while advantages achieved by the prior art are maintained intact.

An embodiment of the present disclosure provides an apparatus for providing a specific notification in a vehicle and a method for the same, capable of notifying a to-do list under various conditions based on a vehicle characteristic in a link with an external to-do list application, and automatically recommending a candidate list of a destination/path based on a to-do list, depending on a user condition and priority, which are set by a user, thereby enhancing the use convenience and the efficiency when moving the vehicle.

Technical problems that may be solved by embodiments of the present disclosure are not limited to the aforementioned problems, and any other technical problems not mentioned herein will be clearly understood from the following description by those skilled in the art to which the present disclosure pertains.

According to an embodiment of the present disclosure, an apparatus for providing a specific notification in a vehicle may include a processor to notify a to-do list based on a vehicle characteristic, in link with a to-do list application (app), and a storage to store data used and an algorithm driven by the processor, in which the processor may recommend a path based on the to-do list, depending on a user condition or priority which is set by the user and used for recommending the path, when the recommendation of the path is required in relation to the to-do list.

According to an embodiment, the apparatus may further include an interface to display the path, or to receive, from the user, a priority condition set by the user to set the user condition or the priority.

According to an embodiment, the processor may classify an item, which requires movement to a specific point, in the to-do list as a first group, an item, which is to manage the vehicle, in the to-do list as a second group, and an item, which is able to be linked with another function in the vehicle, in the to-do list as a third group.

According to an embodiment, the processor may perform at least one of a hands-free call connection notification based on phone connectivity, a message transmission notification linked with a Bluetooth short message service (SMS) transmission function and a KakaoTalk message transmission function, a notification linked with a vehicle location sharing mode function and a pickup mode function, or a gas station notification linked with an in-car payment function, when the to-do list corresponds to the third group.

According to an embodiment, the processor may recommend a place, which is present around a current location or a destination, for performing the to-do list, or set, as the destination, a place, which is present on a current navigation path, for performing the to-do list, when the to-do list corresponds to the first group or the second group.

According to an embodiment, the processor may recommend a path of employing a place for performing the to-do list as the destination, by using at least one of a time or a distance required to the place for performing the to-do list, whether parking is allowed in the place, or a business hour of the place.

According to an embodiment, the processor may recommend a path of employing the place as the destination, depending on whether a parking fee is charged, as well as whether the parking is allowed, and guide the vehicle to a path to a neighboring parking lot when the parking is difficult in the place.

According to an embodiment, the processor may provide, to the user, an expected time taken to the neighboring parking lot by walk, when guiding a path to the neighboring parking lot.

According to an embodiment, the processor may recommend a path of employing the place as the destination, based on information on a real-time situation of a charging station, when the to-do list corresponds to the second group.

According to an embodiment, the processor may recommend a path of employing a place corresponding to the first group or the second group, as a destination, depending on the user condition or the priority, when the to-do list corresponds to the first group or the second group.

According to an embodiment, the processor may determine the priority, depending on importance and a time limit of the to-do list.

According to an embodiment, the apparatus may further include a communication device to receive the to-do list from an external server.

According to another embodiment of the present disclosure, a system may include a specific vehicle notification apparatus to notify a to-do list based on a vehicle characteristic, in link with a to-do list application, and recommend a path based on the to-do list, depending on a user condition or priority which is set by the user and used for recommending the path, when the recommendation of the path is required in relation to the to-do list, and a server to receive a condition for setting the user condition or the priority from a user terminal or the specific vehicle notification apparatus, and provide information on the to-do list app to the specific vehicle notification apparatus, in link with a to-do list app server which provides the to-do list app.

According to an embodiment, the specific vehicle notification apparatus may classify an item, which requires movement to a specific point, in the to-do list as a first group, an item, which is to manage the vehicle, in the to-do list as a second group, and an item, which is able to be linked with another function in the vehicle, in the to-do list as a third group.

According to another embodiment of the present invention, a method for providing a specific notification in a vehicle may include receiving a to-do list in link with a to-do list app, determining priority of the to-do list to perform a notification, and recommending a path based on the to-do list, depending on a user condition or priority which is set by the user and used for recommending the path, when the recommendation of the path is required in relation to the to-do list.

According to an embodiment, the method may further include displaying the path, or receiving, from the user, a priority condition set by the user to set the user condition or the priority.

According to an embodiment, the method may further include classifying an item, which requires movement to a specific point, in the to-do list as a first group, an item, which is to manage the vehicle, in the to-do list as a second group, and an item, which is able to be linked with another function in the vehicle, in the to-do list as a third group.

According to an embodiment, the performing of the notification may include performing at least one of a hands-free call connection notification based on phone connectivity, a message transmission notification linked with a Bluetooth short message service (SMS) transmission function and a KakaoTalk message transmission function, a notification linked with a vehicle location sharing mode function and a pickup mode function, or a gas station notification linked with an in-car payment function, when the to-do list corresponds to the third group.

According to an embodiment, the recommending of the path may include recommending a place, which is present around a current location or a destination, for performing the to-do list, or setting, as the destination, a place, which is present on a current navigation path, for performing the to-do list, when the to-do list corresponds to the first group or the second group.

According to an embodiment, the recommending of the path may include recommending a path of employing a place for performing the to-do list as the destination, by using at least one of a time or a distance required to the place for performing the to-do list, whether parking is allowed in the place, or a business hour of the place.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a block diagram illustrating the configuration of a system for providing a specific notification in a vehicle, according to an embodiment of the present disclosure;

FIG. 2 is a block diagram illustrating the configuration of an apparatus for providing a specific notification in a vehicle, according to an embodiment of the present disclosure;

FIG. 3 is a view illustrating a to-do list, according to an embodiment of the present disclosure;

FIG. 4 is a flowchart illustrating the configuration of an apparatus for providing a specific notification in a vehicle, according to an embodiment of the present disclosure;

FIGS. 5 and 6 are flowcharts illustrating a method for providing a specific notification in the vehicle and for automatically recommending a path based on the notification, according to an embodiment of the present disclosure; and

FIG. 7 illustrates a computing system, according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions will be omitted in order not to unnecessarily obscure the gist of the present disclosure.

In addition, in the following description of components according to an embodiment of the present disclosure, the terms ‘first’, ‘second’, ‘A’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

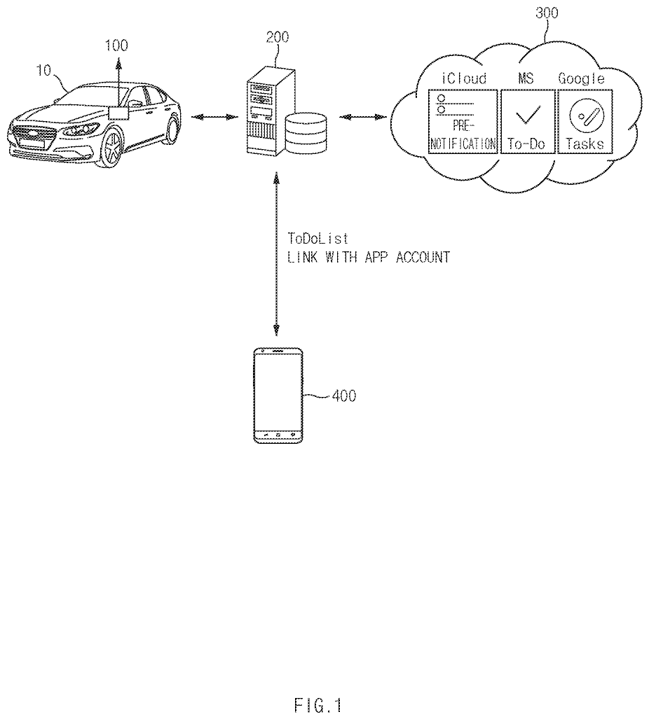

Hereinafter, embodiments of the present disclosure will be described with reference to FIGS. 1 to 7.

FIG. 1 is a block diagram illustrating the configuration of a system for providing a specific notification in a vehicle, according to an embodiment of the present disclosure.

Referring to FIG. 1, according to an embodiment of the present disclosure, the system for providing the specific notification in the vehicle may include an apparatus (specific vehicle notification apparatus) 100 for providing a specific notification in a vehicle, a server 200, a to-do list application (app) server 300, and a user terminal 400.

The specific vehicle notification apparatus 100 may include a connected car terminal (AVNT) that is constantly able to make wireless communication with the server 200.

The specific vehicle notification apparatus 100 may notify a to-do list based on a vehicle characteristic, in the link with a to-do list application, and may recommend a path based on the to-do list, depending on a user condition or priority, which is set by a user and used for recommending the path, when the recommendation of the path is required in relation to the to-do list.

The specific vehicle notification apparatus 100 may be realized inside the vehicle. In this case, the specific vehicle notification apparatus 100 may be formed integrally with the internal control units of the vehicle or may be implemented separately from the internal control units of the vehicle to be connected with the internal control units of the vehicle through a separate connector. A vehicle 10, which has the specific vehicle notification apparatus 100 embedded therein, is a connected car and connected with a communication network to make communication with another vehicle, a traffic and communication infrastructure, or a pedestrian terminal in real time, to help the convenience of a driver and traffic safety, and to provide various services over the Internet.

The server 200 may make communication with the vehicle 10, which is the connected car, the to-do list app server 300, and the user terminal 400, and provides services such as remote control, safety security, vehicle management, and directions. The server 200 may receive a condition for setting a user condition or priority from a user terminal 400 or the specific vehicle notification apparatus 100, and may provide information on the to-do list app to the specific vehicle notification apparatus 100 in the link with the to-do list app server 300 which provides the to-do list app.

The to-do list app server 300 provides the to-do list app to the specific vehicle notification apparatus 100 or the user terminal 400.

The user terminal 400 may include all mobile communication terminals that are portable, such as a smartphone, a tablet personal computer (PC), a personal digital assistant (PDA), a wearable device, or a laptop computer. The user terminal 400 may install a Bluelink app or a to-do list app.

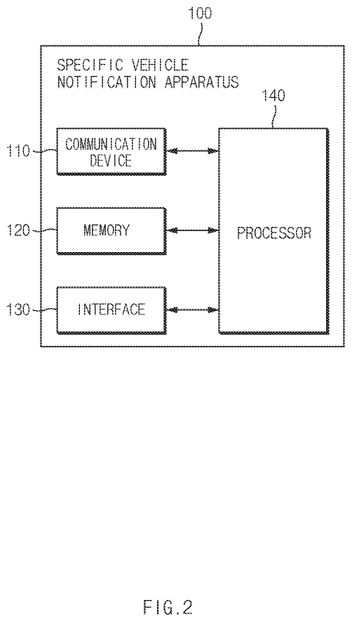

FIG. 2 is a block diagram illustrating the configuration of an apparatus for providing a specific notification in a vehicle, according to an embodiment of the present disclosure.

Referring to FIG. 2, the specific vehicle notification apparatus 100 may include a communication device 110, a memory (i.e., storage) 120, an interface 130, and a processor 140.

The communication device 110 is a hardware device implemented with various electronic circuits to transmit and receive a signal through wireless or wired connection. According to embodiments of the present disclosure, the communication device 110 may transmit or receive information based on in-vehicle devices and in-vehicle network communication technologies. For example, the in-vehicle network communication technology may include a controller area network (CAN) communication technology, a local interconnect network (LIN) communication technology, or a FlexRay communication technology.

In this case, the communication device 110 may make communication with a server, an infrastructure, or another vehicle outside the vehicle through a wireless Internet access technology or a short range communication technology. In this case, the wireless communication technology, which serves as the wireless Internet technology, may include a wireless LAN (WLAN), a wireless broadband (Wibro), a Wi-Fi, or World Interoperability for Microwave Access (Wimax). The short range communication technology may include Bluetooth, ZigBee, ultra wideband (UWB), radio frequency identification (RFID), or infrared data association (IrDA).

For example, the communication device 110 may receive to-do list information from the to-do list app server 300 through the server 200.

The memory 120 may store data and/or algorithms required for the processor 140 to operate. For example, the algorithm may be run to automatically sort a to-do list.

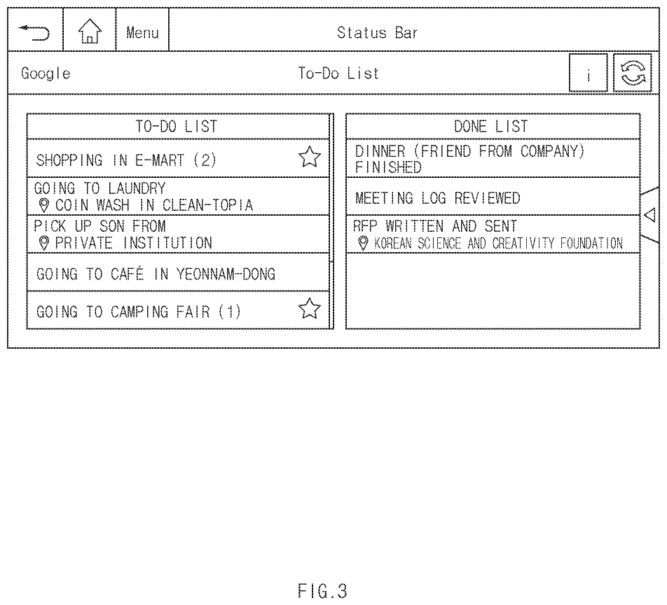

For example, the memory 120 may store a user condition or a condition to determine priority which is set by the user. In addition, the memory 120 may store information on the to-do list received through the server 200, and the information on the to-do list may be illustrated as in FIG. 3. FIG. 3 is a view illustrating a to-do list, according to an embodiment of the present disclosure.

In addition, the memory 120 may include at least one storage medium of a memory in a flash memory type, a hard disk type, a micro type, and the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The interface 130 may include an input device to receive a control command from a user and an output device to output the operation state and the operation result of the specific vehicle notification apparatus 100. In this case, the input device may include a key button, and may include a mouse, a joystick, a jog shuttle, a stylus pen, or the like. In addition, the input device may include a soft key implemented on a display. For an example, the input device may receive, from a user, importance or a processing time limit, which serves as a user condition for automatically recommending a path and a priority condition for determining priority. For example, the user condition may include a distance (radius) for automatic recommendation, a time required in relation to the automatic recommendation, whether parking is allowed, whether a parking fee is required to be paid, whether the parking fee is for free, whether the parking is irrelevant to the parking fee, whether a business hour is considered, or a waiting time for charging.

The interface 130 may be implemented with a head up display (HUD), a cluster, an audio video navigation (AVN), a human machine interface (HMI), or a user select menu (USM).

The output device may include the display and may include a voice output device such as a speaker. In the case that a touch sensor, such as a touch film, a touch sheet, or a touch pad, is included in the display, the display may operate as a touch screen, and may be implemented in the form in which the input device and the output device are integrated with each other. For example, the output device may output a path of employing a place corresponding to the to-do list as a destination, and may output a candidate list of places corresponding to the to-do list.

In this case, the display may include at least one of a liquid crystal display (LCD), a thin film transistor-liquid crystal display (TIFT LCD), an organic light-emitting diode (OLED), a flexible display, a field emission display (FED), or a three dimensional display (3D display).

The processor 140 may be electrically connected with the communication device 110, the memory 120, the interface 130, and the like, may electrically control each component, and may be an electric circuit that executes software commands. Accordingly, the processor 140 may perform various data processing and calculating operations to be described below.

The processor 140 may process a signal transmitted between the components of the specific vehicle notification apparatus 100. The processor 140 may be, for example, an electronic control unit (ECU), a micro controller unit (MCU), or another lower-level controller mounted in the vehicle.

The processor 140 may notify the to-do list based on the vehicle characteristic, in the link with the to-do list app.

In the to-do list, the processor 140 may classify an item, which requires movement to a specific point, as a first group (group 1), an item to manage the vehicle as a second group (group 2), and an item, which is able to be linked with another function in the vehicle, as a third group.

The processor 140 may perform at least one of a hands-free call connection notification based on phone connectivity, a message transmission notification linked with a Bluetooth SMS transmission function and a KakaoTalk message transmission function, a notification linked with a vehicle location sharing mode and a pickup mode function, or a gas station notification linked with an in-car payment function, when the to-do list corresponds to the third group (group 3).

The processor 140 may recommend a path based on the to-do list, depending on a user condition or priority, which is set by the user for the purpose of recommending the path, when the recommendation for the path is required in relation to the to-do list.

In other words, the processor 140 may recommend, as a destination, a place, which is present around a current location or a destination, for performing the to-do list, or set, as a destination, a place, which is present on a current navigation path, for performing the to-do list, when the to-do list corresponds to the first group or the second group. For example, the first group may include shopping in E-mart or going to the laundry. The second group may include washing the car, fueling, charging the electric vehicle, and replacing engine oil. The third group may include making a call to a specific person, having dinner with a specific person, picking up a specific person, and fueling. In this case, the fueling may belong to the second group and the third group, and the processor 140 may perform both functions of a notification and a path recommendation.

The processor 140 may recommend a path of employing a place for performing the to-do list as the destination using at least one of a time or a distance required to a place for performing the to-do list, whether parking is allowed in the place, or a business hour of the place.

The processor 140 may recommend a path of employing the place as the destination, depending on whether a parking fee is charged, as well as whether the parking is allowed. In this case, the processor 140 may guide the vehicle to a path to a neighboring parking lot when the parking is difficult in the place.

The processor 140 may provide, to the user, information on a time taken to reach the neighboring parking lot by walk, when guiding the vehicle to the path to a neighboring parking lot.

The processor 140 may recommend a path of employing a specific place as a destination, based on information on a real-time situation of a charging station, when the to-do list corresponds to the second group.

The processor 140 may recommend a path of employing, as a destination, a place corresponding to the first group or the second group, depending on the user condition or the priority, when the to-do list corresponds to the first group or the second group.

The processor 140 may determine the priority, depending on importance and a time limit of the to-do list.

As described above, according to embodiments of the present invention, beyond merely providing a to-do list of an external app in the terminal of the vehicle, a to-do list specified for the vehicle is reconfigured, a notification is performed in the link with an infotainment function of the terminal, and a candidate list of a destination/path based on the to-do list is automatically recommended depending on the user condition and the priority set by the user, thereby increasing the user convenience and the efficiency of moving the vehicle.

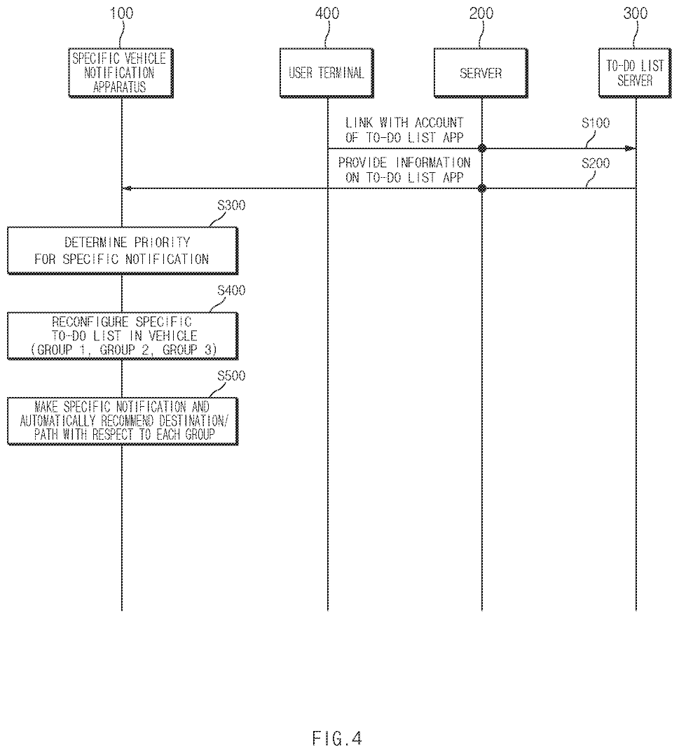

Hereinafter, a method for providing a specific notification in the vehicle will be described with reference to FIG. 4, according to an embodiment of the present disclosure. FIG. 4 is a flowchart illustrating the configuration of an apparatus for providing a specific notification in a vehicle, according to an embodiment of the present disclosure.

Hereinafter, it is assumed that the specific vehicle notification apparatus 100 of FIG. 1 performs the process of FIG. 4. In addition, in the following description made with reference to FIG. 4, it may be understood that the operation described as being performed by the specific vehicle notification apparatus 100 is controlled by the processor 140 of the specific vehicle notification apparatus 100.

First, when the user terminal 400 accesses the to-do list app server 300 through the server 200 (S100), the to-do list app server 300 provides information on the to-do list app to the specific vehicle notification apparatus 100 provided in the vehicle through the server 200 (S200).

Accordingly, the specific vehicle notification apparatus 100 determines priority for an automatic notification, based on the information on the to-do list app, which is received from the server 200 (S300). In this case, the specific vehicle notification apparatus 100 may determine the priority by determining whether the to-do list has to be processed today.

Subsequently, the specific vehicle notification apparatus 100 automatically divides and designates a specific to-do list, which is provided in the vehicle, as a preset group (S400). In other words, the specific vehicle notification apparatus 100 may classify items of the to-do list into group 1, group 2, and group 3.

In this case, group 1 includes an item (for example, shopping in E-mart, or going to the laundry) requiring movement to a specific point. Group 2 may include items related to the management of the vehicle (e.g., washing a car, fueling, charging an electric vehicle, or replacing engine oil). Group 3 may include items (e.g., contacting with XXX, having a dinner with XXX, picking up XXX, or fueling) which are able to be linked with another function (infotainment) in the terminal.

In addition, the specific vehicle notification apparatus 100 performs a specific notification for each group and automatically recommends a destination or path depending on the notification (S500).

In the case of group 1, the specific vehicle notification apparatus 100 performs a notification of recommending a place around a current location or a destination. For example, the specific vehicle notification apparatus 100 may perform a preferential recommendation based on a required time/distance, a recommendation of a place allowing parking, or a recommendation of a place within a business hour. In addition, a notification of recommending a place located on a current navigation path may be performed. For example, the specific vehicle notification apparatus 100 may perform a preferential recommendation based on a time/distance which is additionally required, a recommendation of a place allowing parking, or a recommendation of a place within the business hour.

In the case of group 2, the specific vehicle notification apparatus 100 may provide a notification of recommending a place around a current location or a destination. For example, the specific vehicle notification apparatus 100 may perform a preferential recommendation based on a required time/distance, a recommendation of a place allowing parking, a recommendation of a place within a business hour, or a recommendation based on information on a real-time situation of a charging station. In addition, the specific vehicle notification apparatus 100 may perform a notification of recommending a place on a current navigation path. For example, the specific vehicle notification apparatus 100 may perform a preferential recommendation based on a time/distance which is additionally required, a recommendation of a place allowing parking, a recommendation of a place within a business hour, or a recommendation based on information on a real-time situation of a charging station.

In the case of group 3, the specific vehicle notification apparatus 100 may perform a hands-free call connection notification based on the phone connectivity (Bluetooth/Android Auto/CarPlay) of the terminal. In addition, the specific vehicle notification apparatus 100 may perform a message transmission notification in the link with a Bluetooth short message service (SMS) outgoing function or a KakaoTalk message transmission function of a terminal. In addition, the specific vehicle notification apparatus 100 may perform a notification in the link with a function of sharing the location of a host vehicle/a pick-up mode function of the terminal. The specific vehicle notification apparatus 100 may perform notification of a gas station linked with an in-car payment function of the terminal.

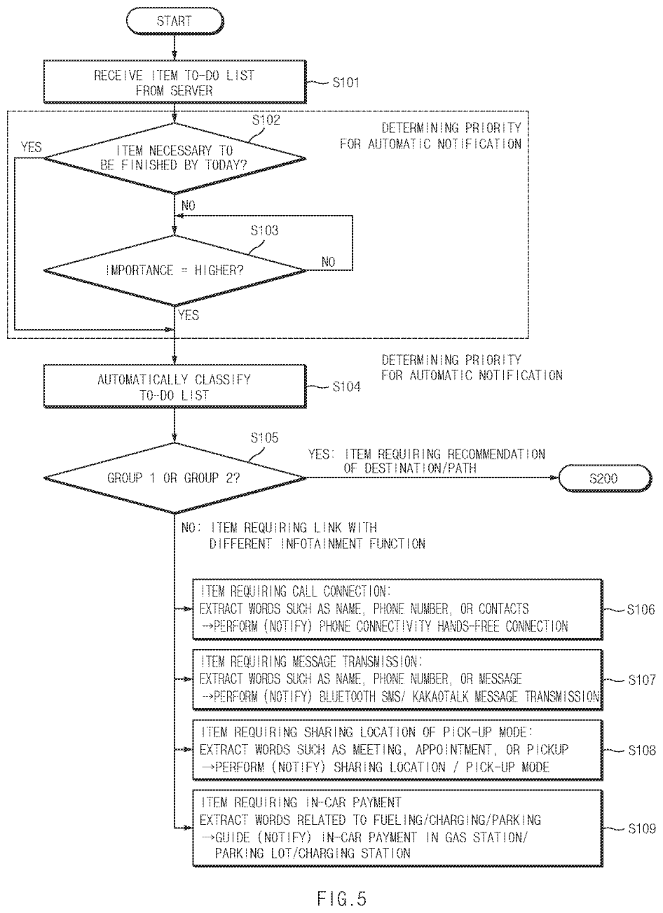

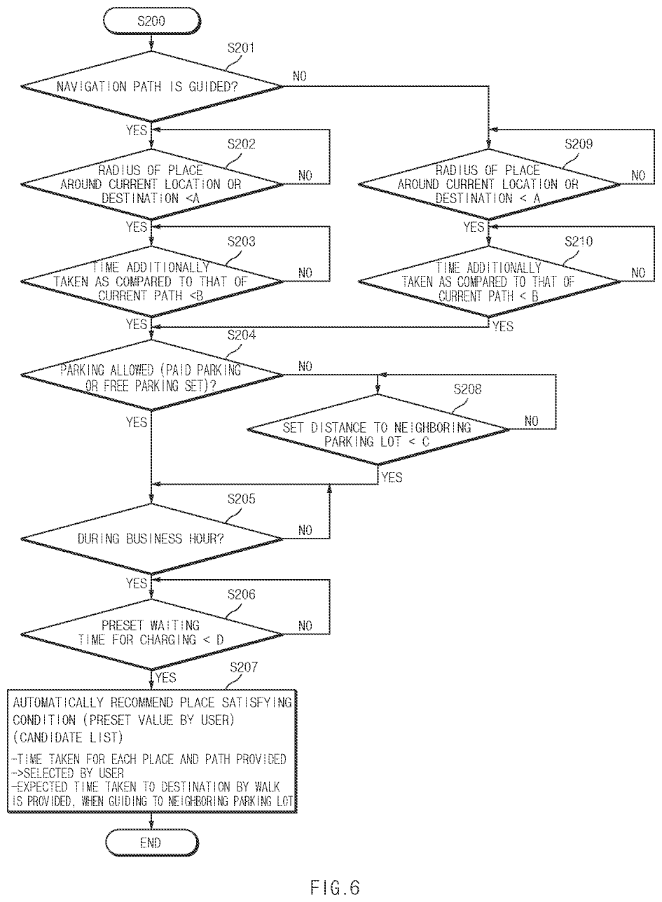

Hereinafter, a method for providing a specific notification in the vehicle and for automatically recommending a path based on the notification will be described with reference to FIGS. 5 and 6, according to an embodiment of the present disclosure. FIGS. 5 and 6 are flowcharts illustrating a method for providing a specific notification in the vehicle and for automatically recommending a path based on the notification, according to an embodiment of the present disclosure.

The following description will be made on the assumption that the specific vehicle notification apparatus 100 of FIG. 1 performs processes of FIGS. 5 and 6. In addition, in the following description made with reference to FIGS. 5 and 6, it may be understood that the operation described as being performed by the specific vehicle notification apparatus 100 is controlled by the processor 140 of the specific vehicle notification apparatus 100.

Referring to FIG. 5, the specific vehicle notification apparatus 100 may receive a to-do list from the server 200 (S101).

The specific vehicle notification apparatus 100 determines whether an item to be finished by today is present in the to-do list (S102), and determines whether the item has higher importance (S103). In other words, the specific vehicle notification apparatus 100 determines the priority for the automatic notification.

In other words, the specific vehicle notification apparatus 100 reconfigures the to-do list and automatically classifies the to-do list for each group, when the item to be finished by today is present or the item has a higher importance (S104).

The specific vehicle notification apparatus 100 determines whether the to-do list corresponds to one of group 1, group 2, or group 3 (S105).

When the to-do list corresponds to group 3 (NO at S105), that is, when the to-do list corresponds to an item which is able to be linked to another function (infotainment) inside the terminal, a word matched with each situation is extracted and the to-do list is notified (S106, S107, S108, or S109).

That is, when the to-do list is related to a call connection, the specific vehicle notification apparatus 100 performs the hands-free call connection notification in the link with a phone connectivity (Bluetooth/Android Auto/CarPlay) function in the vehicle (S106). In this case, the specific vehicle notification apparatus 100 may perform the hands-free call connection notification by extracting items, for example, words such as a name, a phone number, or contacts, necessary for the call connection.

In addition, the specific vehicle notification apparatus 100 may perform the message transmission notification, in the link with the Bluetooth SMS outgoing function or the KakaoTalk message transmission function of the terminal, and may perform the message transmission notification, by extracting items, for example, words such as a name, a phone number, or contacts, necessary for the group message transmission (S107).

In addition, the specific vehicle notification apparatus 100 may perform a notification in the link with the function of sharing the location of the host vehicle/a pick-up mode function inside the terminal. In detail, the specific vehicle notification apparatus 100 may perform the transmission notification in the link with the function of sharing the location of the host vehicle/a pick-up mode function, by extracting items, for example, words such as “meeting”, “appointment”, or “pickup”, necessary for the function of sharing the location/the pick-up mode function (S108).

In addition, the specific vehicle notification apparatus 100 may perform a gas station notification in the link with an in-car payment function of the terminal in a gas station, a parking lot, or a charging station, by extracting items, for example, words such as “refueling”, “charging”, and “parking” of the in-car payment function (S109).

When the to-do list belongs to group 1 or group 2 (YES in S105 of FIG. 5), the procedure of S200 in FIG. 6 is performed.

In other words, when the to-do list belongs to group 1 or group 2 in S105, the specific vehicle notification apparatus 100 determines whether the navigation path is guided (S201), referring to FIG. 6. The specific vehicle notification apparatus 100 determines whether a place to be recommended is present within a preset distance ‘A’ from a current location or a destination when the navigation path is guided (S202). In this case, the preset distance ‘A’ may be set by the user and stored through the user terminal 400 or the specific vehicle notification apparatus 100. For example, the preset distance ‘A’ may be a radius of 1 km, a radius of 2 km, and a radius of 3 km. For example, when the to-do list is related to “fueling”, the specific vehicle notification apparatus 100 may determine whether a gas station is present within the preset distance ‘A’ from the current location. In addition, when the navigation path is guided, the specific vehicle notification apparatus 100 may determine whether the gas station is present within the preset distance ‘A’ from the destination.

Thereafter, when the radius from the current location or the destination is less than the preset distance ‘A’ for automatic recommendation, the specific vehicle notification apparatus 100 determines whether a time (that is, a time additionally required based on the current path) taken to reach a recommended place is less than a preset time ‘B’ (S203). For example, the specific vehicle notification apparatus 100 determines whether a time additionally taken to reach the recommended place, based on the current location or the destination, that is, a time additionally taken as compared to that of the current navigation path is less than the preset time ‘B’. In this case, the preset distance ‘A’ may be set by the user and stored through the user terminal 400 or the specific vehicle notification apparatus 100. For example, the preset time ‘B’ may be set to 10 minutes, 20 minutes, or 30 minutes.

When the time additionally taken, as compared to that the current path is less than the preset time ‘B’, and when “parking allowed” is set by a user, the specific vehicle notification apparatus 100 may determine whether parking is allowed (S204). When the parking is difficult, that is, when a place, which is automatically recommended, has no parking lot, the specific vehicle notification apparatus 100 may recommend a possible distance to a neighboring parking lot. The specific vehicle notification apparatus 100 may guide, to the user, an expected time taken to the neighboring parking lot by walk, when guiding a path to the neighboring parking lot.

In addition, the specific vehicle notification apparatus 100 determines whether a place, which is automatically recommended, within a business hour, when the place automatically recommended allows the parking (S205). In this case, whether the place allows the parking may be received from the user and stored. For example, whether the place allows the parking may be set with information on “pay”, “free”, or “any type of pay or free”). In addition, the possible distance to a neighboring parking lot may be set to be 50 m, 100 m, or 200 m.

When the place automatically recommended is during the business hour, the specific vehicle notification apparatus 100 determines whether a preset waiting time for charging is less than a preset time ‘D’ (S206). In this case, the preset time ‘D’ may be set by the user and stored through the user terminal 400 or the specific vehicle notification apparatus 100. For example, the preset time ‘D’ may be set to 10 minutes, 30 minutes, or 60 minutes.

When a preset waiting time for charging is less than a preset time ‘D’, the specific vehicle notification apparatus 100 may automatically recommend a place satisfying a condition (a preset value by a user) (S207). In this case, the specific vehicle notification apparatus 100 may provide places by generating a candidate list based on priority and may provide a time taken to each place and a path to each place.

In this case, the specific vehicle notification apparatus 100 may set the priority, depending on importance and a time limit of the to-do list. In other words, the specific vehicle notification apparatus 100 may set the priority to be higher, as the importance of the to-do list is higher, and the time limit of the to-do list is earlier, that is, today or this week.

In this case, the importance (higher, middle, or lower) may be set and stored by the user through the user terminal 400 and the specific vehicle notification apparatus 100, such that the priority is determined.

Meanwhile, when the navigation path is not being guided as the determination result (NO in S201), the specific vehicle notification apparatus 100 determines whether a place automatically recommended is present within the preset distance ‘A’ from the current location or the destination when the navigation path is being guided (S209).

When the place automatically recommended is present within the preset distance ‘A’ from the current location or the destination, the specific vehicle notification apparatus 100 may determine whether the time taken to the place automatically recommended from the current location is less than the preset time ‘B’ (S210). When the time taken to the place automatically recommended from the current location is less than the preset time ‘B’, the specific vehicle notification apparatus 100 repeats S204 to S208.

As described above, according to embodiments of the present disclosure, automatic classification, recommendation, and notification functions are provided with respect to a list, which is utilized in a vehicle, of a to-do list, thereby setting a destination/path for the movement to a specific point based on the to-do list, and maximizing the convenience and the usage through the link with a notification function related to the management of the vehicle and a different infotainment function (Bluetooth hands-free call connection function, a function of sharing the location of my vehicle, and an in-car payment function).

In addition, according to embodiments of the present disclosure, a notification and automatic recommendation of a destination/path is made in relation to the to-do list, depending on the priority based on various preset items and determination logic of the user, thereby enhancing the efficiency of the use convenience and the efficiency of the vehicle movement.

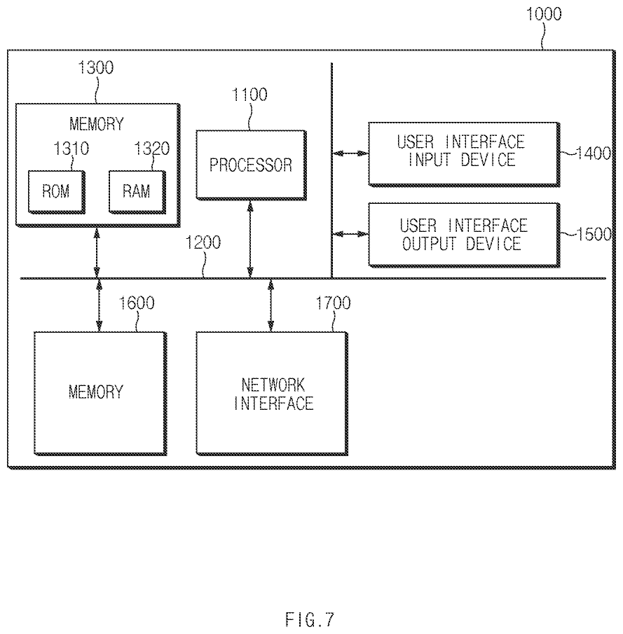

FIG. 7 illustrates a computing system, according to an embodiment of the present disclosure.

Referring to FIG. 7, a computing system 1000 may include at least one processor 1100, a memory 1300, a user interface input device 1400, a user interface output device 1500, a memory (i.e., storage) 1600, and a network interface 1700, which are connected with each other via a bus 1200.

The processor 1100 may be a central processing unit (CPU) or a semiconductor device for processing instructions stored in the memory 1300 and/or the memory 1600. Each of the memory 1300 and the memory 1600 may include various types of volatile or non-volatile storage media. For example, the memory 1300 may include a read only ROM 1310 and a RAM 1320.

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the memory 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

According to embodiments of the present technology, the to-do list may be notified under various conditions based on the vehicle characteristic in the link with the external to-do list application and the candidate list of the destination/path based on the to-do list may be automatically recommended depending on the user condition and priority set by the user, thereby enhancing the use convenience and the efficiency when moving the vehicle.

Besides, a variety of effects directly or indirectly understood through the disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. An apparatus for providing a specific notification in a vehicle, the apparatus comprising:
a processor configured to:
notify a to-do list based on a vehicle characteristic, in link with a to-do list application; and
recommend a path based on the to-do list based on a user condition or priority set by a user and used for recommending the path when the recommendation of the path is required in relation to the to-do list; and
a memory configured to store data used and an algorithm driven by the processor.

2. The apparatus of claim 1, further comprising an interface configured to:
display the path; or
receive, from the user, a priority condition set by the user to set the user condition or the priority.

3. The apparatus of claim 1, wherein the processor is configured to classify a first item requiring movement to a specific point in the to-do list as a first group, a second item for managing the vehicle in the to-do list as a second group, and a third item able to be linked with another function in the vehicle in the to-do list as a third group.

4. The apparatus of claim 3, wherein the processor is configured to perform at least one of a hands-free call connection notification based on phone connectivity, a message transmission notification linked with a Bluetooth SMS transmission function and a messaging application message transmission function, a notification linked with a vehicle location sharing mode function and a pickup mode function, or a gas station notification linked with an in-car payment function, when the to-do list corresponds to the third group.

5. The apparatus of claim 3, wherein, when the to-do list corresponds to the first group or the second group, the processor is configured to:
recommend a place present near a current location or a destination for performing the to-do list; or
set, as the destination, a place present on a current navigation path for performing the to-do list.

6. The apparatus of claim 5, wherein the processor is configured to:
recommend a path to the place for performing the to-do list as the destination, by using at least one of a time or a distance required to the place for performing the to-do list, whether parking is allowed in the place, or a business hour of the place.

7. The apparatus of claim 6, wherein the processor is configured to:
recommend a path to the place as the destination based on whether a parking fee is charged, as well as whether the parking is allowed; and
guide the vehicle to a path to a neighboring parking lot when the parking is difficult in the place.

8. The apparatus of claim 7, wherein the processor is configured to provide, to the user, an expected time taken to the neighboring parking lot by walking, when guiding the path to the neighboring parking lot.

9. The apparatus of claim 6, wherein the processor is configured to recommend a path to the place as the destination based on information on a real-time situation of a charging station when the to-do list corresponds to the second group.

10. The apparatus of claim 3, wherein the processor is configured to:
recommend a path to a place corresponding to the first group or the second group as a destination based on the user condition or the priority when the to-do list corresponds to the first group or the second group.

11. The apparatus of claim 1, wherein the processor is configured to determine the priority based on importance and a time limit of the to-do list.

12. The apparatus of claim 1, further comprising a communication device configured to receive the to-do list from an external server.

13. A system comprising:
a specific vehicle notification apparatus configured to:
notify a to-do list based on a vehicle characteristic, in link with a to-do list application; and
recommend a path based on the to-do list based on a user condition or priority set by a user and used for recommending the path when the recommendation of the path is required in relation to the to-do list; and
a server configured to:
receive a condition for setting the user condition or the priority from a user terminal or the specific vehicle notification apparatus; and
provide information on the to-do list application to the specific vehicle notification apparatus, in link with a to-do list application server that provides the to-do list application.

14. The system of claim 13, wherein the specific vehicle notification apparatus is configured to classify a first item requiring movement to a specific point in the to-do list as a first group, a second item for managing the vehicle in the to-do list as a second group, and a third item able to be linked with another function in the vehicle in the to-do list as a third group.

15. A method for providing a specific notification in a vehicle, the method comprising:
receiving a to-do list in link with a to-do list application;
determining priority of the to-do list to perform a notification; and
recommending a path based on the to-do list based on a user condition or priority set by a user and used for recommending the path when the recommendation of the path is required in relation to the to-do list.

16. The method of claim 15, further comprising:
displaying the path; or
receiving, from the user, a priority condition set by the user to set the user condition or the priority.

17. The method of claim 15, further comprising classifying a first item requiring movement to a specific point in the to-do list as a first group, a second item for managing the vehicle in the to-do list as a second group, and a third item able to be linked with another function in the vehicle in the to-do list as a third group.

18. The method of claim 17, wherein the to-do list corresponds to the third group, and performing the notification includes performing at least one of a hands-free call connection notification based on phone connectivity, a message transmission notification linked with a Bluetooth SMS transmission function and a messaging application message transmission function, a notification linked with a vehicle location sharing mode function and a pickup mode function, or a gas station notification linked with an in-car payment function.

19. The method of claim 17, wherein the to-do list corresponds to the first group or the second group, and recommending the path includes:
recommending a place present near a current location or a destination for performing the to-do list; or
setting, as the destination, a place present on a current navigation path for performing the to-do list.

20. The method of claim 17, wherein recommending the path includes recommending a path to a place for performing the to-do list as a destination, by using at least one of a time or a distance required to the place for performing the to-do list, whether parking is allowed in the place, or a business hour of the place.
